(19) United States
(12) Patent Application Publication
(10) Pub. No.: US 2013/0204521 A1
(43) Pub. Date: Aug. 8, 2013

(54) METHOD FOR FLEXIBLY ADJUSTING A NAVIGATION PATH AND DEVICE THEREOF

(71) Applicants: Inventec Appliances (Pudong) Corporation, Shanghai (CN); Inventec Appliances Corp., New Taipei (TW); Inventec Appliances (Shanghai) Co. Ltd., Shanghai (CN)

(72) Inventors: Chen-Chen Liu, Taipei County (TW); Yi-Hua Ho, Taipei County (TW)

(73) Assignees: INVENTEC APPLIANCES (PUDONG) CORPORATION, Shanghai (CN); INVENTEC APPLIANCES (SHANGHAI) CO. LTD., Shanghai (CN); INVENTEC APPLIANCES CORP., New Taipei (TW)

(21) Appl. No.: 13/759,859

(22) Filed: Feb. 5, 2013

(30) Foreign Application Priority Data
Feb. 7, 2012 (CN) 201210026532.3

(51) Int. Cl. G01C 21/34

(52) U.S. Cl. CPC G01C 21/3453
USPC 701/423

(57) ABSTRACT

The present invention is related to a method for flexibly adjusting a navigation path and a device thereof. The method is applied to a navigation device, and the navigation device may obtain current position information and speed information through a satellite positioning module, then access a map corresponding to the current position information from a map database, continuously the navigation device defines a specific scope adjacent to the vehicle thereof and accesses corresponding traffic sign messages as a changing time in the specific scope from a traffic sign database, then plans a plurality of paths, and respectively calculates the total travel time of each path according to the current speed information and sign features corresponding to traffic signs so as to choose a path with a shortest total travel time as a best navigation path and avoid a path with traffic lights or railroad crossing lights.

### CROSS-REFERENCE TO RELATED APPLICATIONS

This non-provisional application claims priority under 35 U.S.C. §119(a) on Patent Application No. 201210026532.3 filed in China on Feb. 7, 2012, the entire contents of which are hereby incorporated by reference.

### BACKGROUND OF THE INVENTION

1. Field of the Invention

The present invention generally relates to a navigation method and a device thereof, more particularly to a navigation method that flexibly adjusts a path with a shortest travel time according to the state of each traffic sign while a vehicle is moving.

2. Description of the Prior Art

In 1994, American government had constructed a Global Positioning System (GPS), and each user from everywhere in the Earth is satisfied due to that GPS covers almost all over the Earth and has the characteristics of accurate positioning, velocity, and high-precision time standards. For continuous 3-D positioning, 3-D movement and time demand, nowadays GPS is broadly applied to vehicle navigation systems and pedestrian navigation systems. With a high degree of development of network technology, and the sophistication of the electronic industry, the applications of GPS navigation system are not only set in the navigation device, but also can be used in notebook computers, mobile phones, personal digital assistants (PDA) and other electronic products. For clashing the marketing of the navigation system, various producers do their best on the development of operations, display interfaces or computing methods of the navigation system.

Accordingly, the concern of a user to a navigation system is whether the navigation system can plan a best path for the user smoothly going to a destination or not. Generally speaking, the present best method for planning a best path is based on a shortest distance between two places, departure and destination, that is, the navigation system may plan a shortest path according to possible paths, such as highways, bridges, etc., between two places. The computing method is as Dijkstra (single source shortest path), Floyd-Warshall, etc. On the other hand, partial roads may have speed limits as 50 km/hr in city, 60 km/hr in viaduct road, 110 km/hr in highway, etc. So, it can be seen that a shortest path may not be a best way due to speed limit, even spending more time. For solving aforesaid problem, a navigation method that calculates a travel time according to the highest speed limit or average speed limit of every section of a path is developed. For example, while the navigation system plans a plurality of paths and one of the paths may contain high-speed roads or viaduct roads, the navigation system may lead to the path with high-speed roads or viaduct roads for decreasing travel time.

More, although calculating speed limit to be a condition of planning a best path is a theoretical solution for vehicle quickly reaching destinations. Practically, major roads may have traffic signs as traffic lights, railroad crossing lights, etc. so as to extend travel time. Besides, partial roads may have more traffic lights and longer red light, such as 99 sec, due to heavy traffic, and it causes the travel time highly increased, but the navigation system may not re-plan a new path when meeting aforesaid condition, hence all a user can do is just waiting there, and the convenience brought by the navigation system is lost. Thereafter, how to design a brand new navigation method according to aforesaid shortcoming in order to flexibly plan a best path during traveling for decreasing the travel time is an important issue for people skilled in the art.

### SUMMARY OF THE INVENTION

Known navigation methods such as obtaining a path according to a shortest distance between two places and an average or highest speed between two places are still different than a practical travel time, and the path can not be changed in time during the travel time. Such that, the inventor of the present invention has developed a method for flexibly adjusting a navigation path and a device thereof. Through the publication of the present invention, a convenient navigation method is provided to solve aforesaid problems.

The main object of the present invention is to provide a method for flexibly adjusting a navigation path. The method is able to suitably adjust a navigation path according to the real-time state of each traffic sign that a vehicle may pass by in order to decrease a travel time. The method is applied to a navigation device, and the navigation device may obtain current position information of a current position and current speed information of current speed through a satellite positioning module, such as GPS. Then, the navigation device accesses the map corresponding to the current position information from the map database, continuously the navigation device defines a specific scope which has a predetermined distance from the current position and accesses the corresponding traffic sign messages in the specific scope from a traffic sign database, and calculates a path with a shortest total travel time according to current speed information and current traffic state corresponding to each traffic sign so as to avoid a path with traffic lights or railroad crossing lights for highly decreasing the total travel time.

The other object of the present invention is to provide a navigation device that flexibly adjusts a navigation path. The navigation device comprises a satellite positioning module, a storing unit, a processing unit, and a display unit. The processing unit connects with the satellite positioning module, the display unit and the storing unit respectively in order to receive the messages from the satellite positioning module and the storing unit and transmit other messages to the satellite positioning module, the display unit, and the storing unit. In addition, the satellite positioning module can obtain current position information and current speed information. The storing unit stores a map database and a traffic sign database, and the processing unit is capable of executing aforesaid method in order to let a user choose the path with the shortest travel time via the navigation device.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a hard module of the navigation device of the present invention;

FIG. 2 illustrates a schematic flow chart of the navigation method of the present invention;

FIG. 3A illustrates a schematic view of a navigation path R1 of the present invention;

FIG. 3B illustrates a schematic view of a navigation path R2 of the present invention; and

FIG. 3C illustrates a schematic view of a navigation path R3 of the present invention.

### DETAILED DESCRIPTION OF THE INVENTION

Following preferred embodiments and figures will be described in detail so as to achieve aforesaid objects.

The inventor has found that prior navigation method may not adjust a suitable navigation path according to the current traffic signs in a whole travel condition, and such shortcoming causes that the travel time is much longer due to many traffic signs while a user passes through such several traffic signs. For status changes of traffic signs, they are developed by that the relevant government departments develop transform time tables and then transform the states automatically controlled by computers based on the corresponding tables. Accordingly, the inventor has developed a method for flexibly adjusting a navigation path based on the state changes of traffic signs.

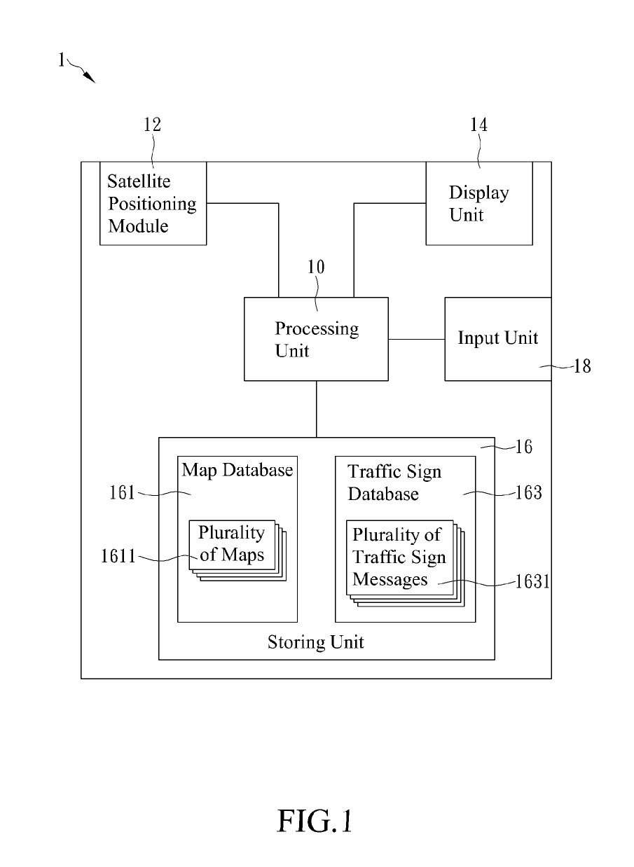

With reference to FIG. 1, the method for flexibly adjusting a navigation path and a device thereof is provided by the present invention and is applied to a navigation device 1. For a preferred embodiment of the present invention, the navigation device 1 has a processing unit 10, a satellite positioning module 12, a display unit 14, a storing unit 16, and an input unit 18. In the preferred embodiment of the present invention, the display unit 14 and the input unit 18 are shown respectively in FIG. 1 . The input unit 18 may be implemented by a button. In other embodiment, the display unit 14 and the input unit 18 may be integrated into a touch panel. The satellite positioning module 12 may be implemented by a Global Positioning System, a Glonass System, or a Beidou Navigation System, The processing unit 10 respectively connects with the satellite positioning module 12, the display unit 14, the storing unit 16, and the input unit 18.

Continuously referring to FIG. 1, the storing unit 16 stores a map database 161 and a traffic sign database 163, wherein the map database 161 has a plurality of maps 1611, each has a plurality of path features of a specific city or a specific area, such as road position, road length, single or two-way path, and path type of Taipei, Taichung, USA or Japan. The path type may be highway, speedway, state road, etc. The traffic sign database 163 has a plurality of traffic sign messages 1631. Each traffic sign message 1631 is corresponding to a traffic sign features of traffic signs. The traffic sign may be a traffic light. The traffic sign feature may be location of traffic sign, status-change, changing time, etc. The status-change may be red, yellow or green light of traffic lights, and has at least one stay-status, such as red light. The stay-status is corresponding to a time-to-status-change. The contents of the traffic sign message 1631 may be messages of a traffic light A, such the traffic light A being located at a crossroad X, and the interval of changing time of the traffic light A from red light , yellow light to green light being T1 to Tn. The red light means stay-status, and the time for the red light transforming to the green light is the time-to-status-change. Aforesaid path feature and traffic sign feature are only one preferred embodiment of the present invention, and are not limitations. Producer may add more traffic signs and codes thereof in the path feature, increase the more codes of the traffic signs in the traffic feature, and omit the locations of the traffic signs.

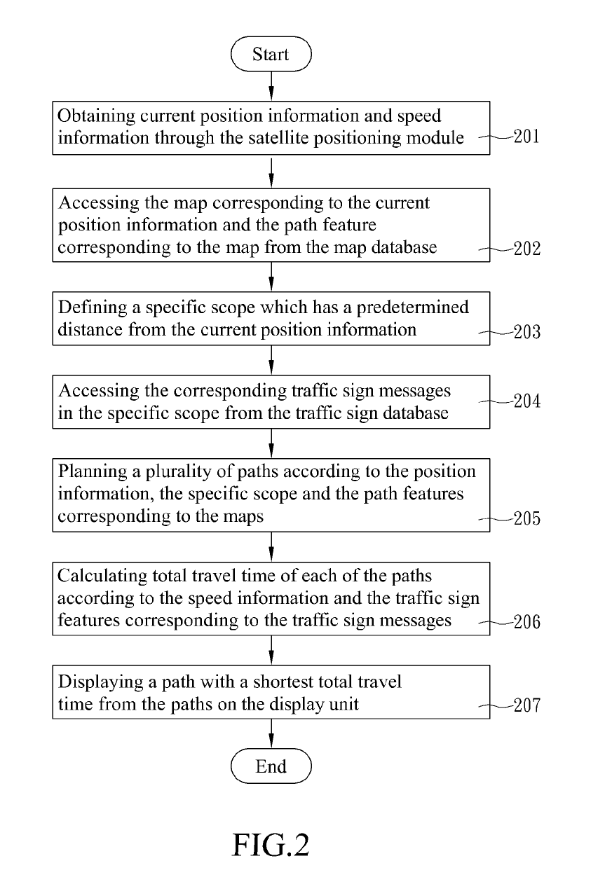

Again, please refer to FIG. 1, while a user wants to go to a location A, the navigation device 1 is activated and the geography information of the location A, such as location name or address, is input through the input unit 18, wherein the geography information is corresponding to a geography location. Thus while the processing unit 10 receives the geography information, corresponding to the geography location of the location A, from the input unit 18, the processing unit 10 may obtain the current location information of a vehicle via the satellite positioning module 12. Simultaneously, the processing unit 10 accesses the corresponding map 1611 from the map database 161 according to the geography location of the location A. The processing unit 10 may plan a best path between the current location and the location A, and display the path on the display unit 14 in order to guide the user to follow the best path. Thereafter, while the user drives a vehicle, the processing unit 10 executes the method provided by the present invention. Please refer to FIG. 2, the method includes the steps of:
(201) obtaining current position information of a current position and speed information of current speed through the satellite positioning module 12;
(202) accessing the map 1611 corresponding to the current position information and the path feature corresponding to the map 1611 from the map database 161;
(203) defining a specific scope which has a predetermined distance from the current position;
(204) accessing the corresponding traffic sign messages 1631 in the specific scope from the traffic sign database 163;
(205) planning a plurality of paths according to the current position information, the specific scope and the path features corresponding to the maps 1611;
(206) calculating total travel time of each of the paths according to the current speed information and the traffic sign features corresponding to the traffic sign messages 1631; and
(207) displaying one of the paths with a shortest total travel time on the display unit 14.

With references to FIG. 1 and FIG. 2 for describing each step in detail, the processing unit 10 may continuously receive satellite signals through the satellite positioning module 12 and access the contents of the satellite signals, such as the data of latitude, longitude and height of vehicle and current speed, so as to obtain current position information and speed information, as step (201). The processing unit 10 receives the position information that defines the latitude as L1, the longitude as L2 and the height as L3, and if aforesaid position information is Section 1, Chengde Road, Taipei, the processing unit 10 may access the map 1611, corresponding to Section 1, Chengde Road, Taipei, of the map database 161 and the corresponding path features, as step (202). The map 1611 and the path features are displayed on the display unit 14 so as to let the user check the map 1611 of Section 1, Chengde Road, Taipei, and intersections, lanes and alleys around the section. The speed of a vehicle may be slow down before the user pass through an intersection, or the vehicle goes to an outside lane in advance while an early turn is reminded by the navigation device 1.

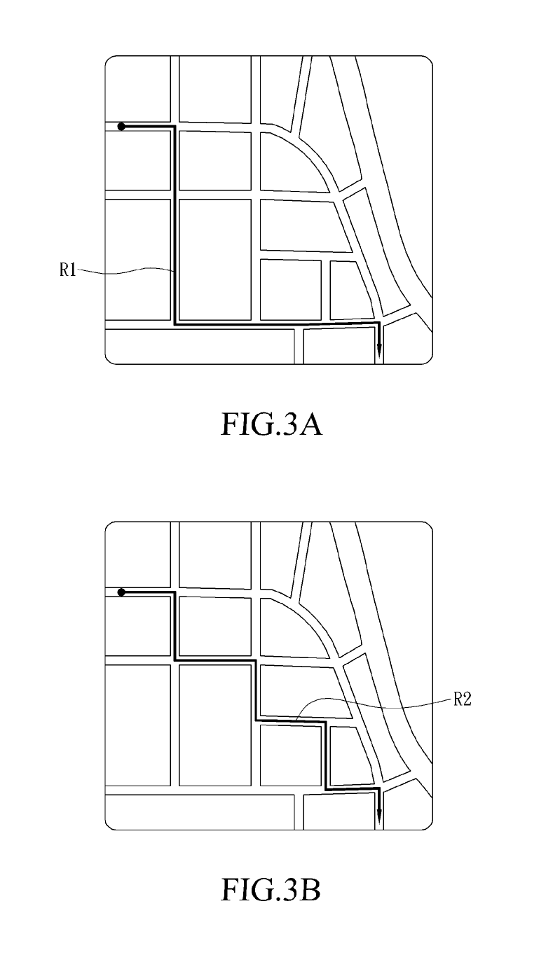

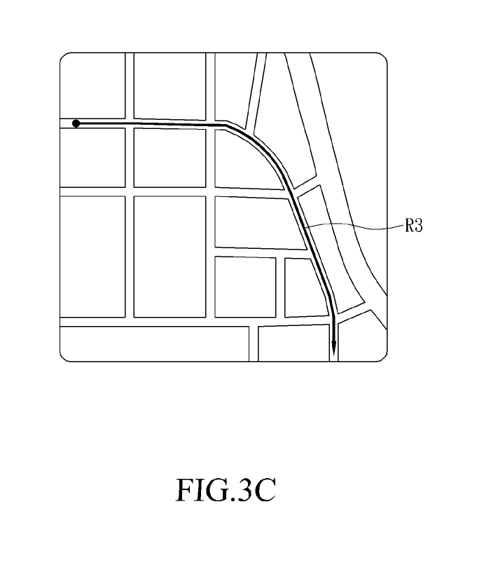

In addition, please refer to FIG. 1 and FIG. 2, while the processing unit 10 accesses the map 1611 corresponding to the current position information, the processing unit 10 may define a specific scope that has a predetermined distance from the current position information, as step (203). For example, the current position of a vehicle is a center, a predetermined distance is a radius as 500 meter, thus the area with the center and the predetermined distance is defined as a specific scope. The processing unit 10 may access the corresponding traffic sign messages 1631 in the specific scope from the traffic sign database 163, as step (204). Thus, the processing unit 10 obtains the traffic sign features of each section of the specific scope, such as traffic sign position and state (red light, yellow light, green light, etc.) of follow-up time interval (T1˜Tn), simultaneously, the state comprises at least one vehicle-stopping state, such as red light. The processing unit 10 may plan a plurality of paths according to the current position information, the specific scope and the path features corresponding to the maps 1611, as step (205), with references to FIG. 3A to FIG. 3C, if the processing unit 10 plans three paths R1, R2 and R3, wherein the travel time for the path R1 in FIG. 3A is 10 min, that is the path length divided by the current speed, and there are eight traffic signs passed by; the travel time for the path R2 is 13 min, and there are thirteen traffic signs passed by; and the travel time for the path R3 is 8 min, and there are six traffic signs passed by, hence the processing unit 10 may determine that what the state of each traffic sign is while a vehicle passes the traffic sign based on that the vehicle with a current speed runs on the paths R1, R2 and R3 respectively. For instance, the path R1 may be blocked by a traffic sign, such as red light, and the corresponded changing time is 60 sec, that is, while a vehicle goes to a traffic sign with the vehicle-stopping state and the stopping time is 60 sec. Therefore, a sign hinder time is 60 sec. The path R2 will not be blocked by traffic sign; the path R3 may be blocked by three traffic signs, and the changing time corresponding to each of the traffic signs in the vehicle-stopping state is 80 sec, that is, the stopping time is 80 sec, and therefore the sign hinder time is 240 sec. As it can be seen, the total travel time of the path R1 is the sum of 10 min of the travel time and 60 sec of the sign hinder time and is about 11 min, for the same reason, the total travel time of the path R2 is about 13 min, the total travel time of the path R3 is about 12 min, as step (206). Since the total travel time of the path R1 is the shortest, and it will be an option by the processing unit 10 for the best path. The path R1 is thus shown on the display unit 14, as step (207), for guiding user.

Please refer to FIG. 1 again, it is to be noted that aforesaid stopping time may be defined as a residue stopping time corresponding to a traffic sign while a vehicle goes to the traffic sign in the vehicle-stopping state. For example, a traffic sign is red and its changing time is 90 sec, and a vehicle goes to the position of the traffic sign after the traffic sign changes to red for 30 sec, the residue stopping time for the vehicle is 60 sec. Besides, aforesaid calculations are to describe in an easy way. As a matter of fact, the travel time will be longer while a vehicle raises its speed. Therefore, the more traffic signs, the total travel time may be highly increased. Through the present invention, the navigation device 1 may know each traffic sign, such as traffic lights and railroad crossing lights, that will be passed by and the in-time state of each traffic sign in advance in order to determine whether the travel time is longer or not. If yes, the path will be adjusted and another path with a shortest travel time may be decided so as to avoid a path with red lights or intersecting railroad for highly decreasing the total travel time.

For aforesaid preferred embodiment and referring to FIG. 1, the navigation device 1 may plan a best path that is defined by a shortest distance between two places, speed limit or the present invention as the state of a traffic sign. No matter how the best path is defined, the present invention may flexibly adjust the path according to the state of each traffic sign that will be passed by in order to choose a path with a shortest total travel time as a best navigation line.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for flexibly adjusting a navigation path, applicable to a navigation device having a map database and a traffic sign database, wherein the map database has a plurality of maps and a plurality of path features corresponding to the maps, the traffic sign database has a plurality of traffic sign messages corresponding to a plurality of traffic sign features respectively, and the method comprises:
obtaining current position information of a current position and current speed information of current speed;
accessing the map corresponding to the current position information and the path feature corresponding to the map from the map database;
defining a specific scope which has a predetermined distance from the current position;
accessing the corresponding traffic sign messages in the specific scope from the traffic sign database;
planning a plurality of paths according to the current position information, the specific scope and the path features corresponding to the maps;
calculating total travel time of each of the paths according to the current speed information and the traffic sign features corresponding to the traffic sign messages; and
displaying one of the paths with a shortest total travel time.

2. The method for flexibly adjusting the navigation path according to claim 1, wherein the path features are selected from the group consisting of position, length, single or two-way path, and path type.

3. The method for flexibly adjusting the navigation path according to claim 2, wherein the traffic sign features are selected from the group consisting of position, state and changing time of traffic signs.

4. The method for flexibly adjusting the navigation path according to claim 3, wherein the state comprises at least one vehicle-stopping state.

5. The method for flexibly adjusting the navigation path according to claim 4, wherein the step of calculating the total travel time of each of the paths comprises the steps of:
obtaining a travel time by a path length of each of the paths in the specific scope being divided by the current speed;
respectively calculating a sign hinder time of each of the paths according to the current speed information while passing each of the traffic signs in the vehicle-stopping state and a stopping time corresponding to each of the traffic signs in the vehicle-stopping state; and
calculating the total travel time according to the sum of the travel time and the corresponding sign hinder time.

6. The method for flexibly adjusting the navigation path according to claim 1 further comprising:
receiving geographical information, wherein the geographic information is corresponding to a geographical position; and
obtaining the current position information, accessing the corresponding maps from the map database according to the geographical information, planning an initial path between the current position and the geographical position, and displaying the initial path.

7. A navigation device comprising:
a satellite positioning module, configured to obtain current position information of a current position and current speed information of current speed;
a storing unit, configured to store a map database and a traffic sign database, the map database having a plurality of maps and a plurality of path features corresponding to the maps, the traffic sign database having a plurality of traffic sign messages corresponding to a plurality of traffic sign features respectively;
a processing unit, connecting with the satellite positioning module and the storing unit respectively, configured to define a specific scope which has a predetermined distance from the current position, configured to access the corresponding traffic sign messages in the specific scope from the traffic sign database, configured to plan a plurality of paths according to the current position information, the specific scope and the path features corresponding to the maps, and configured to calculate total travel time of each of the paths according to the current speed information and the traffic sign features corresponding to the traffic sign messages; and
a display unit, connecting with the processing unit, configured to display a path with a shortest total travel time from the paths.

8. The navigation device according to claim 7, wherein the path features are selected from the group consisting of position, length, single or two-way path, and path type.

9. The navigation device according to claim 8, wherein the traffic sign features are selected from the group consisting of position, state and changing time of traffic signs.

10. The navigation device according to claim 7 further comprising an input unit, connecting with the processing unit, configured to receive geographical information and to transfer the geographical information to the processing unit, the geographic information being corresponding to a geographical position, wherein the processing unit is further configured to obtain the current position information via the satellite positioning module, to access the corresponding maps from the map database according to the geographical information, to plan an initial path between the current position and the geographical position, and the display unit is further configured to display the initial path on.
